(19) United States
(12) Patent Application Publication
(10) Pub. No.: US 2006/0048291 A1
(43) Pub. Date: Mar. 9, 2006

(54) Insect protector shield

(76) Inventor: Effie Lee Sims, Miami, FL (US)

Correspondence Address: Effie L. Sims, 9799 N.W. 26th Avenue, Miami, FL, 33147, US

(21) Appl. No.: 10/918,794

(22) Filed: Aug. 16, 2004

(51) Int. Cl. G21F 3/02

(52) U.S. Cl. 2/456

(57) ABSTRACT

Disclosed is an insect excluding garment designed for protection against most domestic and wild insects. The garment is made of a moderately rigid and extremely lightweight insect obstructing mesh with internal foam core structure supports that cause said mesh to stand away from wearer and is comprised of a removable net headdress affixed to a one piece jumpsuit, with the upper body portion extending from the neck to the ankles of the wearer and has sleeves connected thereto with lower portion extending from the wearer's waist and having leg members incorporated thereto.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention most generally relates to the field of protective garments that protect the user against insects. Most particularly this invention relates to an insect excluding garment made entirely of moderately rigid and extremely lightweight insect obstructing mesh designed and fabricated in a manner which causes the garment to substantially “stand away” from the body of the wearer. Additionally the over all rigidity of the garment is reinforced by the addition of internal foam structures so as to obviate the need for a plurality of fabrics and the need for intermediate fabrics to separate the mesh layer from the wearer's body.

For many years now most outdoor recreational sports enthusiast and scientific researches have been plagued with the frequent and unwelcome annoyance of mosquitoes, black flies and other insects. Countless lotions, repellents and sprays have been developed to ward off these insects but their success is limited. Further more they present a possible health hazard by means of chemical/physiological reactions and or environmental contamination and pollution. More over they are not sufficient enough deterrents to remove any or all possibilities of insects physically contacting a persons exposed extremities and or entering exposed orifices. An object of this invention is to protect the wearer from exposure to insects, without the use of ineffective or potentially dangerous chemical products, through a comfortable protective garment.

Protective clothing and protective garments are known in the prior art. Examples of protective garments in the prior art are disclosed in U.S. Pat. Nos. 3,783,451; 4,395,781; 4,422,184; 4,685,152; 4,716,594; and 4,979,236. These patents are relevant to the Applicants' invention in that they represent the closest prior art disclosing protective garments and the like. None of the above identified patents disclose a garment utilizing both a moderately rigid and extremely lightweight insect obstructing mesh with internal foam core structures as support. Moreover, these unique features outperform the overall protective features of the prior art garments. An added object of the instant invention is to be both low in cost, and easy to wear and remove.

### BRIEF SUMMARY OF THE INVENTION

The stipulated invention in its most simple form or incarnation is directed to a garment that protects users from a variety of insects (most generally mosquitoes and black flies). The insect excluding garment is made entirely of moderately rigid and extremely lightweight insect obstructing mesh. Therefore it inherently is comfortable to don in most weather conditions; whether hot, cold, dry or wet. It is a see trough material that is designed and fabricated in a manner which causes the garment to substantially “stand away” from the body of the wearer with the additional support of internal foam core ring structures. The protective garments rigidity and internal foam core ring structures were also designed and fabricated not to hinder, impede, or obstruct the user's freedom of movement thus rendering the garment comfortable for most any physical exertion. Additionally it is substantially free enough to shift over normal outer garments of the wearer to completely enclose the body of the wearer and protect the wearer from the bother of insects.

A one-piece net headdress and separate full body jumpsuit comprises the garment. The one-piece net headdress fully encloses the head of said wearer and appropriately attaches to said upper body portion of jumpsuit. Said headdress is further comprised of an internal foam ring structure as support adhered to bisectional single stitched net headdress with predetermined incision approximate the mouth and located on forward facing plane of said net headdress; and net headdress seam extending around upper perimeter of net headdress bisection, with said bisection seam being a predetermined and appropriate distance above neck and shoulders of said net headdress terminating edge. The full body jumpsuit adapted to have openings therein appropriately sized and positioned to permit donning by said wearer over an area of said wearer's whole body; additionally internal foam pads are placed equidistant and relative to wearers shoulders. The upper body portion of the garment extends from the neck to proximate the waist of the wearer and has the arms connected thereto. Velcro™ fasteners secure central vertical seam down facing plan of upper body portion terminating below waistband. A pair of sleeves appropriately attached to said upper body portion of jumpsuit; with internal foam ring structures equally spaced along length of wearers arms at predetermined regions as secondary support of the moderately rigid and extremely lightweight insect obstructing mesh. The attached lower body portion extends from the wearer's waist and has the legs connected thereto. Furthermore the waist area of the upper body portion and the lower edges of the sleeves are gathered with the insertion of a means for causing said sleeves to be in substantial contact at the wearer's wrist area and means for causing the upper body portion to be in substantial contact at the wearer's hip area, such as for example an elastic band or a draw string in a casing. The lower edges of the legs are gathered with the insertion of, for example, a pull cord in a casing.

In summary, the invention disclosed herein overcomes the several problems discussed previously. Most notably, the insect protective garment of the instant invention does not provide for additional complicated features and unnecessary openings. Most importantly it has been found that if the mesh is moderately rigid and the internal foam ring structures are strategically placed and are put together in such a manner so as to enhance the rigidity, and the seams are located as taught herein, the moderately rigid and extremely lightweight insect obstructing mesh is all that is needed to provide the protection for the wearer. Additionally, because of the relative simplicity of the garment, it is lower in cost and more people, including children can afford to have and don such a garment.

Further advantages of the present invention will become apparent to those skilled in the art of insect protective garments upon examination of the drawings and the detailed description of the invention.

### BRIEF DESCRIPTION OF THE SEVERAL VIEWS OF THE DRAWING

FIG. 1 is a front view of the one-piece net headdress and full body jumpsuit portions of the garment embodying the invention.

FIG. 2 is an enhanced front view detailing various features and components of the one-piece net headdress and full body jumpsuit portions of the garment embodying the invention; and

FIG. 3 is an enhanced front view detailing the various internal features and structures of the one-piece net headdress and full body jumpsuit portions of the garment embodying the invention.

### DETAILED DESCRIPTION OF THE INVENTION

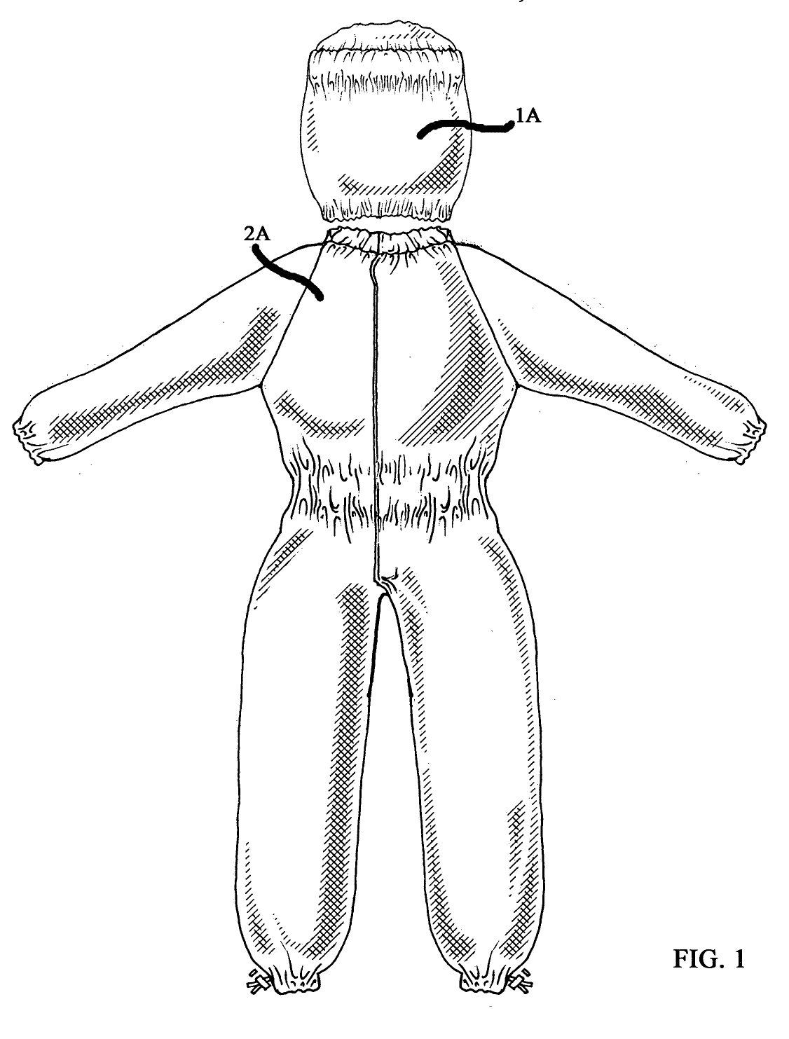

Referring now to the drawings and in particular to FIG. 1, there is illustrated, at both 1A and 2A, the present invention in the form of an insect excluding one-piece net headdress and full body jumpsuit garment.

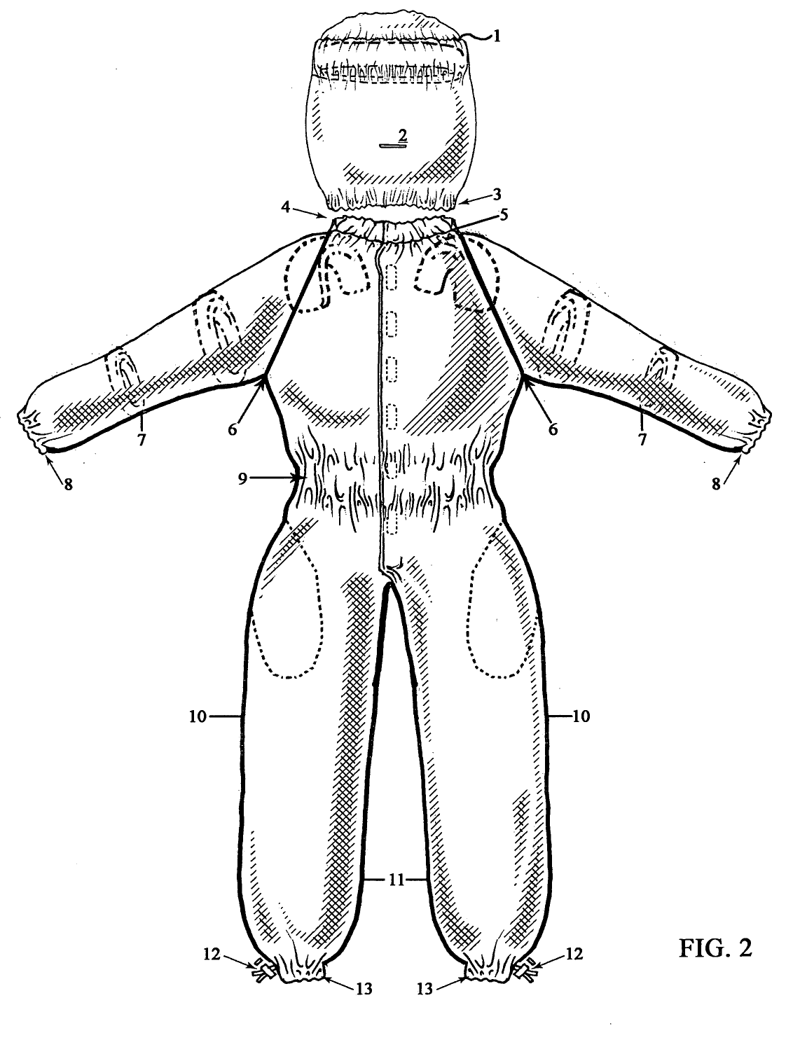

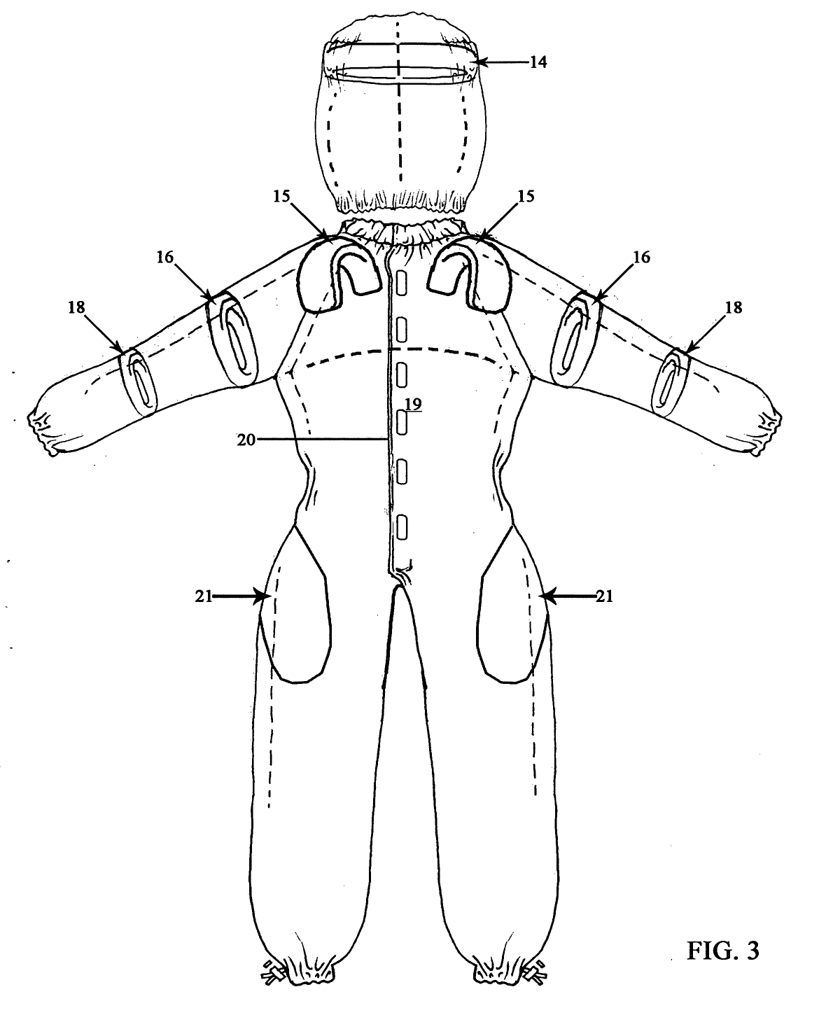

In FIG. 2 and FIG. 3 there is illustrated the various components and features of instant invention as it applies to the assembly and functionality of the garments embodiments. The double stitched seam 1 connects two circular mesh panels to each other making one garment. This new unified mesh garment is then attached to the internal foam core ring structure 14 by means of a double stitch. Lower portion of adjoined mesh panels approximate the seam 1 is further adhered to internal foam core ring structure with glue adhesive. At the terminating edge of the lowest extremity of the adjoined mesh panels is a double stitched casing housing an elastic band 3. Additionally on forward facing plane approximate the mouth is placed a stitched incision 2 for efficient access to mouth without compromising net headdress protective quality.

The jumpsuit portion of the instant invention is comprised of four full length body portions of mesh connected together by double stitched seams located at 10 and 11 respectively. On the forward facing plane of the assembled four panels of jumpsuit is a open seam 20 that runs the length of the upper torso and terminates below elastic waste section 9 at crotch area. This central seam is used as primary means to enter and exit jumpsuit by way of six Velcro fasteners 19 approximate the primary seam and connected there to. Terminating edge approximate the neck connects an elastic casing 4 by way of double stitched seam 5 to upper most region of torso. This elastic casing is used to secure one-piece headdress 1A when donned, to full body jumpsuit 2A donned there after.

Full body jumpsuit 2A has, connected there to, arm sections with double stitched seams located at 6 and internal foam core structures 15 for shoulder support for insect excluding garment when donned. The insect excluding garment which comprises the arm sections of instant invention are comprised of a single mesh panel joined together with double stitched seam 7 and two strategically placed internal foam core ring structures 16 and 18. These foam structures are the primary means of elevating insect excluding garment from skin and thus providing superior protection to prior art. At terminating edge approximate the wrist are additional elastic bands 8 secured in double stitched casing.

For the lower portion of full body jumpsuit are leg members comprised of double stitched seams 10 and 11 with large internal pockets 21 attached there to. At terminating edge approximate the ankle are double stitched casing 13 enclosing pull cord fasteners 12.

It is thought that the insect excluding garment of the present invention and many of its attendant advantages is understood from the foregoing description. Additionally it will be apparent that various changes may be made in the form, construction and arrangement of the parts thereof without departing from the spirit and scope of the invention or sacrificing all of its material advantages, the form hereinbefore described being merely a preferred or exemplary embodiment thereof.

We claim:

1. An insect excluding garment variably sized and configured to cover majority of a wearer thereof comprising:
A full body jumpsuit adapted to have openings therein appropriately sized and positioned to permit donning by said wearer over an area of said wearer's whole body; Velcro fasteners secure central vertical seam down facing plan of upper body portion terminating at waistband; additionally internal foam pads are placed equidistant and relative to wearers shoulders.
A pair of sleeves appropriately attached to said upper body portion of jumpsuit; with internal foam ring structures equally spaced along length of wearers arms at predetermined regions as secondary support of the moderately rigid and extremely lightweight insect obstructing mesh.
A one-piece net headdress which fully encloses the head of said wearer and appropriately attached to said upper body portion of jumpsuit, said full body jumpsuit, said pair of sleeves and said head net formed of a single layer of see-through moderately rigid and extremely lightweight insect obstructing mesh and wherein said net headdress further comprises; an internal foam ring structure as support adhered to bisectional single stitched net headdress with predetermined incision approximate the mouth and located on forward facing plane of said net headdress; and net headdress seam extending around upper perimeter of net headdress bisection, with said bisection seam being a predetermined and appropriate distance above neck and shoulders of said net headdress terminating edge.

2. The insect excluding garment according to claim 1 further comprising means for causing said sleeves to be in substantial contact at the wearer's wrist area; and means for causing said full body jumpsuit to be in substantial contact at the wearer's hip area.

3. The insect excluding garment according to claim 1 wherein said head net further comprises a small mouth aperture positioned proximate to the mouth of said wearer.

4. The insect excluding garment according to claim 2 further comprising remainder lower body portion of full body jumpsuit formed of moderately rigid and extremely lightweight insect obstructing mesh having a pair of leg members and extending from about the wearer's waist and covering at least a majority portion of said wearer's lower body.

5. The insect excluding garment according to claim 4 further comprising means for causing said leg members to be in substantial contact at the wearer's ankle area; and means for causing said lower body portion of full body jumpsuit to be in substantial contact at the wearer's waist area.
